(19) United States
(12) Patent Application Publication
(10) Pub. No.: US 2019/0244233 A1
(43) Pub. Date: Aug. 8, 2019

(54) METHOD, DEVICE AND SYSTEM FOR PROVIDING RANDOM ADDITIONAL POST-PAYMENT DISCOUNT FOR ELECTRONIC COMMERCIAL TRANSACTION IN OPEN MARKET

(71) Applicant: Chan Go KANG, Seoul (KR)

(72) Inventor: Chan Go KANG, Seoul (KR)

(21) Appl. No.: 16/317,311

(22) PCT Filed: Sep. 20, 2017
(86) PCT No.: PCT/KR2017/010303

§ 371 Date: Jan. 11, 2019

(30) Foreign Application Priority Data
Sep. 20, 2016 (KR) 10-2016-0120107

(51) Int. Cl. G06Q 30/02; G06Q 30/06

(52) U.S. Cl. CPC G06Q 30/0222; G06Q 30/0613

(57) ABSTRACT

The present invention relates to a method, apparatus and system for providing a random additional post-payment discount for electronic commercial transactions in an open market, and particularly to a method, apparatus and system for providing a random additional post-payment discount of 1% to 100% of the initial payment amount after the purchase price has been paid when you select one or more products for purchase in an online open market where virtual sales space is offered to unspecified number of sellers.

### CROSS-REFERENCE TO RELATED APPLICATIONS

This application claims the benefit of Korean Patent Application No. 10-2016-0120107 filed with the Korean Intellectual Property Office on Sep. 20, 2016, the disclosures of which are incorporated herein by reference.

### TECHNICAL FIELD

The present invention relates to a method, apparatus and system for providing random additional post-payment discount in electronic commercial transaction or e-commerce in an open market, and more particularly, to a method, apparatus and system for providing random additional discount of 1 to 100% of the initial payment amount after the purchase price has been paid when you select one or more products (hereinafter, goods and services will be collectively referred to as ‘products’) for purchase in an online open market where virtual sales space is offered to unspecified number of sellers.

### BACKGROUND

With the development of Internet technology, online electronic commerce or online shopping has been growing rapidly and the scale of the transactions is continuously expanding. The online shopping platforms can be broadly divided into personal shopping mall, general shopping mall and open market.

The online shopping platform which has recently been bigger and become a hot spot is an open market which provides a virtual sales space to unspecified number of sellers. The operator of the open market receives sales commission from the seller in exchange for selling the online market space.

From the perspectives of the operator of the open market and the sellers who sells their own products in the open market, the key to the business is the marketing that can maximize their sales. While various marketing programs are applied for sales maximization, the most popular one is a discount coupon.

In a discount coupon event, the seller usually accepts the reduction in profit due to the discount, or both the seller and the open market operator share the loss in profit at a predetermined rate. Therefore, in order to prevent the deterioration in their profit rate, the event period should be selected as a short term and the amount of discount must be properly controlled.

In this situation, you cannot offer a discount coupon event every day for 365 days nor you can offer a discount of at least 1 to 100% of the buyer's purchase amount. This is because the seller must be guaranteed his or her own cost and margin in the sales and the open market operator must receive the transaction fee or sales commission within the sales amount as his or her income.

In order to promote the overall sales in the electronic commerce, Korean Laid-Open Patent Application No. 10-2005-0101115 (Laid-Open on Oct. 20, 2005) discloses an idea of providing a discount coupon of about 50%, for example, of the sales amount and lowering the discount rate every time a predetermined period is over. However, there have been some problems in that the buyer could not use the discount coupon at the time of the purchase, the buyer could use the discount coupon only if the buyer with the discount coupon buys another product, and there was no measure to make up for the considerable loss of the seller due to the discount.

### SUMMARY

The present invention has been proposed in the background as described above, and it is a purpose of the present invention to provide a virtual sales space on-line for an unspecified number of sellers when a buyer selects one or more products and purchases the products, and provide a method, apparatus, and system for increasing the purchasing desire of the buyer by providing an additional discount at random from 1% to 100% based on the payment amount that the buyer has paid.

In addition, it is another purpose of the present invention to provide a method, apparatus and system wherein the seller can secure his or her own profits even when finally paid price is less than the cost of the product and even if it is sold at 100% discount or free of charge, since the open market operator, not the seller, supports the fund for the random additional discount based on the sales commission paid by the seller according to the sales of the product.

Further, it is another purpose of the present invention to provide a method, apparatus, and system capable of maximizing the sales of sellers without burdening the additional cost of the seller even if the random additional discount event is continuously performed 365 days a year.

Still further, it is another purpose of the present invention to provide a method, apparatus and system wherein the open market operator can secure his or her own profit with a paid membership fee regardless of the discount amount for the random additional discount, since the open market operator provides the random additional discount service to the paid member buyer and/or the paid member seller.

Still further, it is another purpose of the present invention to provide a method, apparatus and system wherein the buyer's desire to purchase is increased by displaying the amount of financial source for the random additional discount service in total and range of each random additional discount to the buyer in the open market, and the buyer can purchase the product at a substantially lower price even though the membership fee is required for the registration of the buyer.

Still further, it is another purpose of the present invention to provide a method, apparatus and system that induce the buyer, seller and the open market operator to trade in a more advantageous and more stable environment through the condition of guaranteeing profit through paid membership and random additional discount service within the range of the sales commission.

### Technical Solution

In order to accomplish the above-mentioned purposes, some embodiments of the present invention provides a random additional discount apparatus for receiving at least one random additional discount target product from a seller terminal, receiving a random additional discount request from a buyer terminal upon payment for a purchase of the product and providing a random additional discount price to the buyer terminal in response to the random additional discount request,

wherein the apparatus is configured to: extract a random additional discount amount in response to the random additional discount request; determine whether the extracted random additional discount amount satisfies a predetermined condition; transmit the random additional discount price determined by the random additional discount amount satisfying the predetermined condition to the buyer terminal; and repeat the process of extracting a new random additional discount amount and determining whether the new random additional discount amount satisfies the predetermined condition, and

wherein the predetermined condition that the determined random additional discount amount Dᵢ should satisfy is ΣCₖ−ΣDₖ≥0,

when M sellers sell products on the open market the total result of product sales by the M seller for a predetermined period of time is summarized as follows:

R_{T}=ΣR₁+ΣR₂+ . . . ΣRₖ+ . . . +ΣR_{M}

(Here, ΣRₖ=sales revenue of the seller k, R_{T}=total sales revenue of all the M sellers);

C_{T}=ΣC₁+ΣC₂+ . . . ΣCₖ+ . . . +ΣC_{M}

(Here, ΣCₖ=sales commission received from the seller k, C_{T}=total sales commission received from all the M sellers);

D_{T}=ΣD₁+ΣD₂+ . . . ΣDₖ+ . . . +ΣD_{M}

(Here, ΣDₖ=discount subsidy provided by the open market operator for the sales of the product of the seller k, DT=total discount subsidy provided by the open market operator for the sales of the products of all the M sellers).

In addition, another embodiment of the present invention provides a random additional discount apparatus for receiving at least one random additional discount target product from a seller terminal, receiving a random additional discount request from a buyer terminal upon payment for a purchase of the random additional discount target product and providing a random additional discount price to the buyer terminal in response to the random additional discount request,

wherein the apparatus is configured to: extract a random additional discount amount in response to the random additional discount request; determine whether the extracted random additional discount amount satisfies a predetermined condition; transmit the random additional discount price determined by the random additional discount amount satisfying the predetermined condition to the buyer terminal; and repeat the process of extracting a new random additional discount amount and determining whether the new random additional discount amount satisfies satisfies the predetermined condition, and

wherein the predetermined condition that the determined random additional discount amount Dᵢ should satisfy is C_{T}−D_{T}≥0, when M sellers sell products on the open market the total result of product sales by the M seller for a predetermined period of time is summarized as follows:

R_{T}=ΣR₁+ΣR₂+ . . . ΣRₖ+ . . . +ΣR_{M}

(Here, ΣRₖ=sales revenue of the seller k, R_{T}=total sales revenue of all the M sellers);

C_{T}=ΣC₁+ΣC₂+ . . . ΣCₖ+ . . . +ΣC_{M}

(Here, ΣCₖ=sales commission received from the seller k, C_{T}=total sales commission received from all the M sellers);

D_{T}=ΣD₁+ΣD₂+ . . . ΣDₖ+ . . . +ΣD_{M}

(Here, ΣDₖ=discount subsidy provided by the open market operator for the sales of the product of the seller k, D_{T}=total discount subsidy provided by the open market operator for the sales of the products of all the M sellers).

The predetermined condition that the determined random additional discount amount Di should satisfy is C_{T}−D_{T}≥0 and ΣCₖ−ΣDₖ≥0, wherein, if Cₖ−Dₖ<0 then it is determined whether the condition C_{T}−D_{T}≥M_{TH} is satisfied; if the condition C_{T}−D_{T}≥M_{TH} is satisfied then the determined random additional discount price is transmitted to the buyer terminal; if the condition C_{T}−D_{T}≥M_{TH} is not satisfied then the process of extracting a new random additional discount amount and determining whether the new random additional discount amount satisfies the above conditions is repeated; and

M_{TH} is the threshold margin of the open market operator for the sales of products of all the M sellers for the predetermined period.

The total amount of the discount subsidy that will be applied to the random additional discount service is displayed on the buyer terminal.

In addition, a further embodiment of the present invention provides a random additional discount method provided by a random additional discount apparatus for receiving at least one random additional discount target product from a seller terminal, receiving a random additional discount request from a buyer terminal upon payment for a purchase of the random additional discount target product and providing a random additional discount price to the buyer terminal in response to the random additional discount request,

wherein the method comprises: receiving from the seller terminal the seller information and at least one random additional discount target product for registration; receiving from the buyer terminal the buyer information and payment completion information for a product to purchase; in response to the payment completion information, transmitting at least one random additional discount price to the buyer terminal; and receiving from the buyer terminal a purchase decision,

wherein the transmitting further comprises: extracting a random additional discount amount; determining whether the extracted random additional discount amount satisfies a predetermined condition; when the determined random additional discount amount satisfies the predetermined condition, transmitting the determined random additional discount price to the buyer terminal; and when the determined random additional discount amount does not satisfy the predetermined condition, repeating the steps of extracting a new random additional discount amount, determining whether the new random additional discount amount satisfies the predetermined condition and transmitting the determined new random additional discount price satisfying the predetermined condition to the buyer terminal, and

wherein the predetermined condition that the determined random additional discount amount Dᵢ should satisfy is C_{T}−D_{T}≥0,

wherein, when M sellers sell products on the open market the total result of product sales by the M seller for a predetermined period of time is summarized as follows:

R_{T}=ΣR₁+ΣR₂+ . . . ΣRₖ+ . . . +ΣR_{M}

(Here, ΣRₖ=sales revenue of the seller k, R_{T}=total sales revenue of all the M sellers);

C_{T}=ΣC₁+ΣC₂+ . . . ΣCₖ+ . . . +ΣC_{M}

(Here, ΣCₖ=sales commission received from the seller k, C_{T}=total sales commission received from all the M sellers);

D_{T}=ΣD₁+ΣD₂+ . . . ΣDₖ+ . . . +ΣD_{M}

(Here, ΣDₖ=discount subsidy provided by the open market operator for the sales of the product of the seller k, D_{T}=total discount subsidy provided by the open market operator for the sales of the products of all the M sellers).

The predetermined condition that the determined random additional discount amount Dᵢ should satisfy is C_{T}−D_{T}≥0 and ΣCₖ−ΣDₖ≥0,

wherein, if Cₖ−Dₖ<0 then it is determined whether the condition C_{T}−D_{T}≥M_{TH} is satisfied;

if the condition C_{T}−D_{T}≥M_{TH} is satisfied then the determined random additional discount price is transmitted to the buyer terminal; if the condition C_{T}−D_{T}≥M_{TH} is not satisfied then the process of extracting a new random additional discount amount and determining whether the new random additional discount amount satisfies the above conditions is repeated; and

M_{TH} is the threshold margin of the open market operator for the sales of products of all the M sellers for the predetermined period.

The total amount of the discount subsidy that will be applied to the random additional discount service is displayed on the buyer terminal.

The random additional discount method further comprises: after receiving the payment completion information, transmitting a random additional discount request mark to the buyer terminal, and the random additional discount request from the buyer terminal is implemented by the selection of the random additional discount request mark by the buyer terminal.

The random additional discount price is between 1% and 100% of the initial price of the product contained in the payment completion information.

The transmitting of the random additional discount price further comprises: in response to the random additional discount request, transmitting a first random additional discount price to the buyer terminal; receiving again the random additional discount request from the buyer terminal; and transmitting a second random additional discount price to the buyer terminal, and

the receiving of the purchase decision from the buyer terminal further comprises: receiving the purchase decision corresponding to one of the first and second random additional prices.

### Advantageous Effects

According to an aspect of the present invention, there is provided a method, apparatus and system to provide a virtual sales space on-line for an unspecified number of sellers when a buyer selects one or more products and purchases the products, and to increase the purchasing desire of the buyer by providing an additional discount at random from 1% to 100% based on the payment amount that the buyer has paid.

According to other aspect of the present invention, there is provided a method, apparatus and system wherein the seller can secure his or her own profits even when finally paid price is less than the cost of the product and even if it is sold at 100% discount or free of charge, since the open market operator, not the seller, supports the fund for the random additional discount based on the sales commission paid by the seller according to the sales of the product.

According to another aspect of the present invention, there is provided a method, apparatus, and system capable of maximizing the sales of sellers without burdening the additional cost of the seller even if the random additional discount event is continuously performed 365 days a year.

According to another aspect of the present invention, there is provided a method, apparatus and system wherein the open market operator can secure his or her own profit with a paid membership fee regardless of the discount amount for the random additional discount, since the open market operator provides the random additional discount service to the paid member buyer and/or the paid member seller.

According to another aspect of the present invention, there is provided a method, apparatus and system wherein the buyer's desire to purchase is increased by displaying the amount of financial source for the random additional discount service in total and range of each random additional discount to the buyer in the open market, and the buyer can purchase the product at a substantially lower price even though the membership fee is required for the registration of the buyer.

According to another aspect of the present invention, there is provided a method, apparatus and system that induce the buyer, seller and the open market operator to trade in a more advantageous and more stable environment through the condition of guaranteeing profit through paid membership and random additional discount service within the range of the sales commission.

### BRIEF DESCRIPTION OF THE DRAWINGS

FIG. 1 is a schematic diagram of a random additional post-payment discount according to some embodiments of the present invention.

FIG. 2 is a block diagram of a system for providing random additional post-payment discount according to some embodiments of the present invention.

FIG. 3 is flowchart of a method for providing random additional post-payment discount according to some embodiments of the present invention.

FIG. 4 is a block diagram of an apparatus for providing random additional post-payment discount according to some embodiments of the present invention.

### DESCRIPTION OF EMBODIMENTS

Hereinafter, the present invention will be described with reference to the accompanying drawings. Although the present invention has been described with reference to some embodiments of the present invention, the scope of the present invention is not limited to the above embodiments. For the sake of clarity, the detailed description for insignificant part of the present invention may be omitted, and the same reference numerals will be given to the same components throughout the specification, if available.

It is to be understood that when an element is referred to as “comprising” in the specification and claims it does not exclude the other elements unless specifically stated otherwise.

In addition, operations performed in a plurality of separately described servers or terminals may be performed in an integrated single or a few server(s) or terminal(s), and such changes may be freely performed by those skilled in the art.

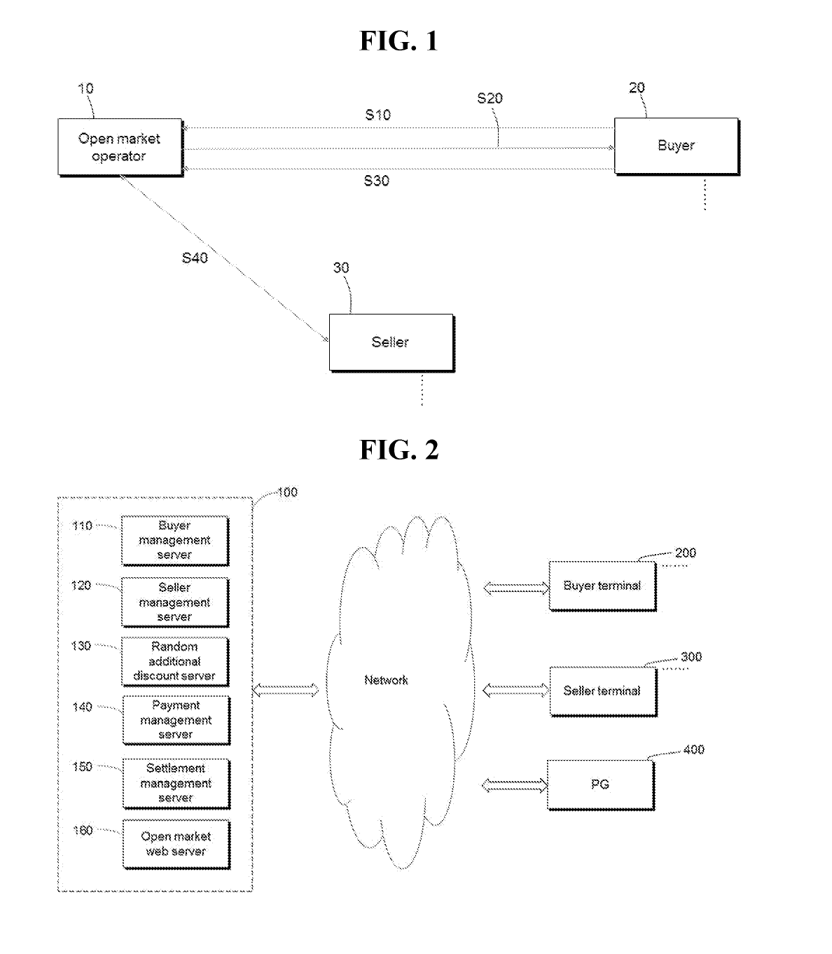

FIG. 1 is a schematic diagram of a random additional post-payment discount according to some embodiments of the present invention.

In case of a typical open market, an open market operator 10 provides the open market as an online shopping place to both the seller 30 and the buyer 20, and the entity who sells products in the open market is the seller 30. Although the buyer 20 pays the price of product on the open market website operated by the open market operator 10, the entity who sells the product is not the open market operator 10 but the seller 30 since the open market operator 10 and the seller 30 perform a financial settlement afterwards including calculation of sales commission due to the sales of the product. Further, it is also the seller 30 who provides a discount to the buyer 20 when selling the products for promotion of sales.

However, in the random additional post-payment discount according to some embodiments of the present invention, the entity who provides a random additional discount is the open market operator 10. The basic concept of the random additional post-payment discount of the present invention is that, after the buyer 20 has paid the product in a normal manner in the open market website, the open market operator 10 provides an additional discount opportunity to the buyer 20 with a discount rate at random between 1% and 100% on the initial payment amount of the product and the buyer 20 cancels the initial payment and makes the payment again for the same product at a discounted price according to rate of the random additional post-payment discount. This re-payment process can be implemented in various forms, which will be explained in detail later.

Referring to FIG. 1, when a buyer 20 makes an initial payment to buy a product at step S10, the open market operator 10 provides a random additional discount at a random rate selected between 1% to 100% of the initial price, i.e., 50% at step S20, and the buyer 20 makes the payment again at a discounted price which is 50% lower than the initial price of the same product at step S30. Finally, the seller 30 and the open market operator 10 perform a financial settlement between themselves for the total amount of payments that have been made for the seller's products for a predetermined period of time at step S40.

In another embodiment, if a 20% discount has been applied to an original price of a product by a seller 30, the discounted price given by the seller 30 would also be the initial price and the buyer 20 would make an initial payment at the initial price which is 80% of the original price to buy the initially discounted product at step S10. Then, the open market operator 10 would give a random additional post-payment payment discount of 50% of the initial price at step S20 and the buyer 20 would make a re-payment for the same product at a discount price which is 40% lower than the original price of the product at step 30. At last, the seller 30 and the open market operator 10 would proceed with a financial settlement between themselves for the total amount of payments that have been made for the products of that seller 30 for a predetermined period of time at step S40.

Here, the initial discount of 20% of the original price is a conventional discount amount given by the seller 30 at the cost of the reduction in the seller's profit. The additional discount of 50% of the initial price is a different discount amount given by the open market operator 10 at the cost of the reduction in the open market operator's profit. The initial discount of 20% is not included in the random additional discount given by the open marker operator 10 of the present invention. Therefore, the random additional discount means an additional discount given by the open market operator 10 to the basic price or the initial price, where the basic price or the initial price offered by the seller 30 is a selling price given to the buyer 20 after applying all the seller's own discount plan to the product.

In FIG. 1, the ‘additional discount’ or ‘random additional discount’ is implemented by the buyer's first payment at the initial price by cash or credit card and the buyer's second payment at discounted price due to the random additional discount after cancelling the first payment. Otherwise, the buyer's confirmation of purchase to pay for the product at the initial price may be regarded as the first payment and then the buyer's real payment at discounted price due to the random additional discount will be regarded as the second payment. In this case, the real payment for product with cash or credit card is done only once. Further, after the first real payment for product, an amount of points equal to the discounted amount due to random additional discount may be provided to the buyer and the buyer may cancel the first payment and make a second payment using the points at a discounted price. The concept of random additional post-payment discount of the present invention covers all the above cases.

It will be understood by those skilled in the art that various forms of the first and second payments can be applied to the respective embodiments described without departing from the scope of the present invention.

FIG. 2 is a schematic diagram of random additional post-payment system according to some embodiment of the present invention.

The overall environment of FIG. 2 comprises a random additional discount system 100 connected via a conventional network such as Internet to a plurality of buyer terminals 200, a plurality of seller terminals 300 and payment gateway PG 400.

The random additional discount system 100 comprises a buyer management server 110, a seller management server 120, a random additional discount server 130, a payment management server 140, a settlement management server 150, and an open market web server 160. Where functions required to implement the random additional discount are provided to a conventional open market operation system, then the open market operation system can be regarded as a random additional discount system 100 of the present invention.

Herein, the number of terminals and servers are illustrated only for explanation and the plurality of terminals or servers may be physically replaced with a single integrated terminal or server, respectively. Even when a single terminal or server is depicted, it does not exclude the use of a plurality of terminals and servers. Thus, it is to be understood that some part of the functions or components described in the following description may be implemented by being integrated with other server or component without departing from the scope of the present invention.

First, each buyer terminal 200 is used to register the buyer in the buyer management server 110 of the random additional discount system 100 through a membership joining procedure including an agreement to pay a predetermined monthly fee to the open market operator. The buyer terminal 200 may search the product to buy in the open market web server 160 and make payment for the purchase of the product. Since the buyers are preferably paid members who pay monthly membership fee the basic income and cost of the open market operator can be covered by the paid membership fee. Thus, the basic income and cost of the open market operator may not be affected by the discount subsidies for random additional discount provided to the buyers.

In the real-time random additional discount service according to some embodiments of the present invention, the grade of the paid member may be designated in consideration of the amount of monthly paid fee, the payment status, the total purchase amount, and other usage status of the paid member. By adjusting the range of the discount rate of the random additional discount according to the grade of the membership, it is possible to provide a differentiated service so that the higher discount rate is presented to the high-graded member. In such a case, differentiated service details for each customer are registered in the buyer management server 110, and the random additional discount service for each customer is performed accordingly.

Each seller terminal 300 is used to register the seller in a seller management server 120 of the random additional discount system 100 through a predetermined procedure including an agreement to pay a sales commission to the open market operator based on the sales of the product. The seller terminal 300 may register product information such as basic information, images and other sales conditions of the target product for random additional discount in the open market web server 160 and/or the seller management server 120.

According to some embodiments, the seller may be a paid seller member who has agreed to pay a monthly fee, in such case, the basic income and cost of the open market operator is covered by the paid membership fee from the buyer member and the seller member and they are not affected by discount subsidies for random additional discounts offered to the buyer.

When the open market is a dedicated random additional discount open market providing random additional discount services for all the products, all the products registered by the seller terminal 300 become random additional discount target products. However, when a random additional discount corner is operated as a special section of the conventional open market, the seller terminal 300 can distinguish the random additional discount target product from other sales products and register the products in different sections of the open market web server 120.

In some cases, the seller terminal 300 may be allowed to set a random additional discount period for the products, the expected sales for that period, and the range of a random additional discount rate to be presented to the buyer. However, in order to do this, it is necessary for the seller to share the financial burden due to the random additional discount with the open market operator by using the settlement management server 150, or the seller must be registered with the seller management server 120 as a high-graded seller and be granted such setting authority from the open market operator.

The payment gateway, PG 400 means an electronic payment agent server. In some embodiments of the present invention, the PG 400 comprises all kinds of servers in the payment gateway corporation which performs or proceeds with electronic payments in connection with the seller terminal 300, the seller's POS (Point of Sales) system, the payment management server 140 and/or external financial institutions at the time of electronic payment at the buyer's terminal 200 using the buyer's credit card or other payment means of the buyer in the online or offline market. Here, the external financial institution preferably includes credit card companies, banks, communication companies, and escrow companies so that the electronic payment accommodate various payment means such as credit card, account transfer, virtual account, payment using mobile phone and escrow service.

When the buyer requests a payment at a random additional discount price, the PG 400 connects the seller terminal 300, the seller's POS (point of sale) system (not shown), the payment management server 140 and/or the external financial institution (not shown) to proceed with the electronic payment. The PG 400 interoperates with the payment management server 140 to support the buyer and/or seller so that they can re-pay the same product at a random additional discount price after the initial payment.

The random additional discount system 100 includes a buyer management server 110, a seller management server 120, a random additional discount server 130, a payment management server 140, a settlement management server 150, and open market web server 160.

The buyer management server 110 provides, in cooperation with the open market web server 160, a web page for the registration and the management of the buyer who intends to purchase the product using a random additional discount service, and manages the registered buyer's personal information, payment information, purchase information, grade, and the like.

To this end, the buyer management server 110 can store various data necessary for operation into a buyer management DB. The buyer management DB stores various data required for performing electronic commerce activities and measuring e-commerce usage in the open market including, but not limited to, personal information for each buyer (a corporate information when the buyer is a corporation), payment information, grade information, monthly fee information, point information and coupon information for each buyer.

The payment information for each buyer means the details of the payment made by a buyer in the open market. The grade information for each buyer means a user grade or a user rating set by the random additional discount system 100 according to the open market usage status of the buyer. The point information is the point information paid to each buyer through the random additional discount when the random additional discount amount is provided in the form of point payment. The coupon information is the information of the coupon paid to the buyer, coupon usage status information, and the information of the additional coupon paid to the buyer according to the coupon usage status.

The seller management server 120 provides a web page for registration and management of the seller who intends to sell the product using a random additional discount service in association with the open market web server 160. The web page is also use for registering and managing the product. The seller management server 120 manages the personal/corporate information and other information regarding payment, sales, grade, sales commission, and the like of each seller member.

To this end, the seller management server 120 can store various data necessary for operation into a seller management DB. The seller management DB stores various data required for performing electronic commerce activities and measuring e-commerce usage in the open market including, but not limited to, personal/corporate information, payment information, grade information, monthly fee information, point information, coupon information and event/promotion information for each seller.

The payment information for each seller refers to the payment history information of the seller's products sold in the open market. The grade information for each seller indicates a user grade or a user rating set by the random additional discount system 100 according to the open market usage status of the seller. The point information of each seller is the point information due to the random additional discount on the products of each seller when the random additional discount amount is provided in the form of point payment. The coupon information of each seller includes information of the coupons given by the seller and coupon usage status information of the given coupons.

The seller may purchase the product as a buyer in the open market. In this case, the purchase information of the seller is stored in the buyer management DB. In the case where the buyer DB and the seller DB are not strictly separated according to the structure of the database, the information as buyer and seller for each individual or corporation may be managed as one DB.

The random additional discount management server 130 can communicate with the buyer terminal 200 in cooperation with the open market web server 160 in order to select a discount rate of, for example, 1% to 100% for the product that the buyer has paid for at an initial price (that is, the original or self-discounted price offered by the seller) and determine a discounted amount due to the random additional discount.

To this end, the random additional discount server 130 automatically calculates a random additional discount price discounted at a predetermined ratio or a predetermined amount with respect to the initial price of the product in response to the completion of the initial payment for the product by the buyer terminal 200. Alternatively, once payment is completed by the buyer terminal 200, the random additional discount server 130 provides the buyer terminal 200 with a predetermined random additional discount request mark (e.g., a button, a link or an advertisement, etc.) requesting a random additional discount. If there is a random additional discount request (e.g., button click, etc.) from the buyer, a random additional discount price may be presented to the buyer terminal 200 in response thereto.

For example, if a discount rate of 100% is selected and the random additional discount price is determined to be free, the buyer can purchase the product free of charge and the buyer terminal 200 only transmits the purchase confirmation to the payment management server 140.

According to some embodiments, a random additional discount server 130 may provide a new random additional discount request mark together with a random additional discount price, and if the buyer is not satisfied with the random additional discount price, he or she may request another random discount request using the random additional discount request mark. In response to the buyer's request for another random additional discount, the random additional discount server 130 may present again the modified random additional discount price to the buyer terminal 200.

In this way, the buyer can repeatedly request a random additional discount as many as a predetermined number for random additional discounts. At this time, the final purchase price may be the final random additional discount price, or it may be a price selected by the buyer among the initial price and the subsequently presented random additional discount prices. Of course, when it is not possible to provide a further random additional discount service in response to the repeated random additional discount request from the buyer, the random additional discount server 130 transmits a relevant message to the buyer terminal 200.

Meanwhile, according to some embodiments of the present invention, when a grade is given for each seller registered in the seller management server 120, or when a grade is given for each buyer registered in the buyer management server 110, the random additional discount server 130 may inquire the buyer management server 110 and/or the seller management server 120 to determine different discount rates according to the grade of the buyer and/or seller and then present the different additional discount rates to each buyer or to the products of each seller in response to the random additional discount request from the buyer terminal 200.

The random additional discount management server 130 may limit the final purchase price as the first random additional discount price or limit the number of random additional discount requests. In this case, the random additional discount management server 130 may allow the buyer to purchase a random additional discount item that increases the number of opportunities for random additional discounts. Such a random additional discount item may be purchased for a fee by the buyer terminal 200, or alternatively it may be provided to the buyer as a prize of a promotional event provided by the open market operator.

According to some embodiments of the present invention, the number of the opportunities for random additional discounts may be set by the seller in advance with respect to his or her products and registered in the seller management server 120, and the random additional discount server 130 refers to the seller management server 120 to perform the random additional discount for those products.

For this, the random additional discount server 130 may store various data necessary for operation into a random additional discount DB. The random additional discount DB includes, but not limited to, random additional discount price calculation algorithm used for determining the random additional discount price, grade information for each seller, grade information for each buyer, random additional discount mark information, random additional discount coupon information, information on the number of opportunities for random additional discount, random addition discount target product information, open market promotion/event information, random additional discount history information for each buyer and seller.

The grade information for each seller and for each buyer are the same as those stored in the seller management DB and the buyer management DB, respectively. They are used to differentiate the discount rate determination of random additional discounts, or at least to affect the discount rate decision depending on the grade given to each seller and each buyer.

The random additional discount mark information is the mark information which is publicly displayed on the buyer terminal 200 to indicate that the product is a target for random additional discount. It can also be displayed on the buyer terminal 200 to indicate that another random additional discount is possible when a buyer who has been given a random additional discount price wishes to request another random additional discount price.

Random additional discount coupon information is information about coupons that provide additional random discount opportunities.

The random additional discount number information is information indicating the number of opportunities for random additional discounts that can be offered to a buyer who repeatedly requests a random additional discount on the same product and it may be set and stored for each product, buyer and seller. In the case of a buyer having a random additional discount coupon, the random additional discount number information is updated according to the content of the coupon.

The random additional discount product information is product information of the target product for random additional discount. The target products may include the random additional discount target products specified by the seller, random additional discount target products set in advance in the random additional discount system 100 as well as the random additional discount target products designated in real time by the random additional discount server 130 according to the buyer's request during the purchase process.

Open market promotion/event Information is information about various events and promotions provided by the open market operator. It includes various information regarding the promotion and/or event that affect the random additional discount process.

The random additional discount history information for each buyer and seller is the discount amount information received or paid by the random additional discount process for each buyer and seller.

The payment management server 140 is notified that the final purchase price has been confirmed from the random additional discount server 130 and in response to this, in connection with the buyer terminal 200, the PG 400 and/or external financial institutions (not shown), proceed with the payment of the buyer's random additional discount product and save the related record.

The payment management server 140 also transmits purchase history information for each buyer to the buyer management server 110 and transmits sales history information for each seller to the seller management server 120. The payment management server 140 also transmits the sales history information for each seller to the settlement management server 150 so that the open market operator and the seller can settle the discount subsidies between them due to the random additional discounts and sales commissions for the sale of the products.

For this, the payment management server 140 may store various data necessary for operation in the payment DB, and the payment DB includes payment information for each buyer, payment information for each seller, and payment information for each product. The payment information for each buyer and the payment information for each seller are the same as those in the buyer management DB and the seller management DB, respectively. The payment information for each product covers all payment information for the products sold in the open market and thus includes the price information before and after applying the random additional discounts and/or coupons.

The open market operator receives the sales commission from the seller member for the sales of the product that used the random additional post-payment discount service, receives the monthly fee from the seller and buyer members who subscribed as the paid member, and supports the seller with discount amount of the random additional discounts based on the above income so that the seller does not lose the profit due to the random additional post-payment discount service. The settlement process is performed through the settlement management server 150 of the random additional discount system 100.

The settlement management server 150 calculates the total amount of discount subsidies for compensating discounted amounts due to random additional post-payment discount service based on the sales and payment information for each seller and each product received from the payment management server 140.

The settlement management server 150 offsets the total amount of the sales commissions to be received from each seller by the total amount of the discount subsidies to be paid for each seller and receives the reduced net sales commission from each seller. In some cases, the discount subsidy for a certain seller may be greater than the total sales commission from that seller, but when the total number of sellers and the buyer are considered, in principle, the total amount of discount subsidy is generally less than the total amount of sales commission.

The settlement management server 150 stores various data for operation in a settlement management DB. The settlement management DB includes, among others, payment information for each seller, payment information for each buyer, discount subsidy calculation information for each seller, discount subsidy calculation information for each buyer, discount subsidy calculation information for each period, sales commission information for each seller, monthly fee information for each seller, monthly fee information for each buyer, and usage information for cash, credit card, gift certificate, and other types of securities.

The discount subsidy calculation information for each seller, the discount subsidy calculation information for each buyer, and the discount subsidy calculation information for each period are information of discount subsidy calculation for each product in terms of the buyer, seller and the period, respectively.

The sales commission information for each seller is a predetermined commission (for example, about 5 to 30% of the product selling price or normally about about 20% of the product selling price) that each seller has agreed to pay to the open open market operator depending on the sales of each product. Monthly fee information for each seller and monthly fee information for each buyer are the information about the monthly fees paid by the seller and the buyer, respectively, to the open market operator.

The information of the settlement management DB includes all the information about the amount of money that forms the basic fund and cost necessary to provide the discount subsidy and point which is originally regarded as the asset of the open market operator. The information includes sales price of all products sold by the open market operator, sales commission thereof, monthly fees of sellers and buyers as well as the discount subsidy information for each seller, buyer and period.

The open market web server 160, a means for providing the online open market to the buyers and sellers, operates in conjunction with other servers of the random additional discount system 100 and provides interface with the buyer terminal 200 and seller terminal 300.

The individual transaction in the random additional discount service using the random additional discount system 100 configured as explained above will be described in detail. The basic or initial price of the product sold through the random additional post-payment discount is referred to as a revenue R of the product, the amount of sales commission that the open market operator receives from the seller according to the sales of the product is referred to as a commission C, and the discounted amount according to the random additional discount is referred to as a discount subsidy D. Then,

The price paid by the buyer=R−D,

The settled amount provided to the seller by the open market operator=R−C

The settled amount to the open market operator=R−D−(R−C)=C−D.

For example, if the sales commission C is 20% of the sales revenue and the discount subsidy D is 50% of the sales revenue, the settlement amount to the open market operator becomes −30% of sales revenue and the open market operator bears loss.

However, this is a situation that can occur when only a single product is considered. In a real situation, a plurality of products of a seller are sold for a predetermined period and it will be explained in detail.

If a plurality of buyers purchased N products from a certain seller for a predetermined period, the sum of the initial amounts of the products sold through the random additional post-payment discount during the same period is referred to as the sum of sales ΣR of that seller, the sum of the amount of sales commissions that the open market operator receives from that seller according to the sales of the products during the predetermined period is referred to as the sum of sales commission ΣC, and the sum of the discounted amounts due to the random additional discount is referred to as the sum of the discount subsidy ΣD. Then, the results of the sales of the products for the predetermined period of time can be summarized as follows:

ΣRᵢ=R₁+R₂+ . . . Rᵢ+ . . . +R_{N}

ΣCᵢ=C₁+C₂+ . . . Cᵢ+ . . . +C_{N}

ΣDᵢ=D₁+D₂+ . . . Dᵢ+ . . . +D_{N}

That seller's settlement amount received from the open market operator

=ΣRᵢ−ΣCᵢ=ΣR−ΣC

The open market operator's settlement amount to that seller

=ΣRᵢ−ΣDᵢ−(ΣRᵢ−ΣCᵢ)=ΣCᵢ−ΣDᵢ=ΣC−ΣD

Here, ΣC−ΣD≥0

For example, in the case of selling a single product, the sales commission Cᵢ may be lower than the discount subsidy Dᵢ, resulting in the open market operator's loss. However, considering that a plurality number of products are sold for a predetermined period, each discount subsidy Dᵢ is determined at random from 1% to 100% of the initial price and it is possible to design the software algorithm at the random additional discount server 130 so as to always determine each discount subsidy Dᵢ satisfying the condition ΣC≥ΣD.

The software algorithm includes the process of determining whether the random additional discount amount extracted by use of the random function satisfies the above condition, presenting the extracted random additional discount amount to the buyer when the above condition is satisfied, and newly extracting the random additional discount amount using the random function again if the above condition is not satisfied.

Further, the software algorithm includes the process of extracting the another random additional discount amount using the random function again when the buyer rejects the random additional discount amount presented to him or her that satisfies the above condition, and determining if the another random additional discount amount satisfies the above condition again.

While the foregoing has described for the case of a single seller who sold products to a plurality of buyers, the above logic holds true even in the general case where the open market operator is in cooperation with a plurality of sellers. That is, the software algorithm at the random additional discount server 130 can be designed so that the ΣC≥ΣD condition is always satisfied for all sellers on the open market.

For example, when M sellers sell products on the open market, the total result of product sales by the M sellers for a predetermined period can be summarized as follows:

R_{T}=ΣR₁+ΣR₂+ . . . ΣRₖ+ . . . +ΣR_{M}

C_{T}=ΣC₁+ΣC₂+ . . . ΣCₖ+ . . . +ΣC_{M}

D_{T}=ΣD₁+ΣD₂+ . . . ΣDₖ+ . . . +ΣD_{M}

All sellers' total amount of settlement received from the open market operator=R_{T}−C_{T},

The open market operator's total amount of settlement with respect to all sellers

=R_{T}−D_{T}−(R_{T}−C_{T})=C_{T}−D_{T}

Here, C_{T}−D_{T}≥0,

Where, Rₖ=ΣRᵢ, Cₖ=ΣCᵢ, Dₖ=ΣDᵢ

For example, it is advantageous for the open market operator not to suffer any loss for any seller by always satisfying the condition Cₖ−Dₖ≥0 for an arbitrary seller k. In some cases, the open market operator may suffer loss for the certain seller k such as Cₖ<Dₖ, but he or she may not suffer loss if C_{T}≥D_{T} in consideration of all sellers. Then, the open market operator can determine the random additional discount rate more dynamically and encourage the buyer's willingness to purchase.

Therefore, it is important to design a software algorithm at the random additional discount server 130 so that the software algorithm always satisfy the condition C_{T}≥D_{T} when determining each of the discount subsidy amount in the range of 1% to 100% of the initial price at the time of selling a plurality number of products for a predetermined period of time.

Meanwhile, if the predetermined period is the same in calculating the sales revenue ΣR, the sales commission ΣC, and the discount subsidy ΣD, it is desirable to calculate the sales revenue Rᵢ, the sales commission Cᵢ, and the discount subsidy Dᵢ for each seller and each product at the time of selling the product so that each discount subsidy Dᵢ can satisfy the condition ΣC−ΣD≥0.

Alternatively, a predetermined period may be different in calculating the sales revenue ΣR, the sales commission ΣC, and the discount subsidy ΣD. For example, based on the sales revenue ΣR and/or the sales commission ΣC of the sellers in a predetermined period of the past, the discount subsidy ΣD to be applied for a predetermined period in the future after a specific point in time can be calculated and, in such as, each discount subsidy Dᵢ can be calculated to satisfy the condition ΣC−ΣD≥0.

In this case, future discount subsidies are calculated based on past sales records, and a situation where ΣC_{future(real time)}−ΣD_{future(real time)}<0 may occur instantaneously or for a certain period of time even if the condition ΣCₚₐₛₜ−ΣD_{future}≥0 is met. Therefore, even in such a case, it is possible to provide a random additional post-payment discount service on condition of ΣC_{Tpast}≥ΣD_{Tfuture}, that is the sum of all sales commissions from all sellers in the past is larger than or equal to the sum of all discount subsidies to all buyers to a certain period of time in the future.

Meanwhile, the random additional discount server 130 may display the total amount of the discount subsidies that will be applied to the random additional post-payment discount service on the buyer terminal 200, thereby stimulating the buyer's motivation for purchase.

At this time, the total discount amount displayed on the buyer terminal 200 may be the total discount amount Dₖ for the seller k of the product that the buyer desires to purchase, or the total discount amount D_{T} for all sellers in the open market. The process of displaying the total discount amount is an important feature of the present invention because the buyer is motivated to purchase products by anticipating the random additional discount amount for his or her product based on the displayed total discount amount.

At a particular moment, the discount amount Dₖ and/or D_{T} may be displayed as zero, but even under this situation it is desirable to provide a random additional discount service at a discount rate between 1% and 100%. Considering a certain period of time, since the open market operator's settlement amount of Cₖ−Dₖ for a specific seller k or the open market operators settlement amount of C_{T}−D_{T} for all sellers in the open market usually have a positive value, you can provide a random additional discount service even when the total discount amount is zero temporally.

However, in order to provide the random additional discount service even when the total discount amount is zero, the software algorithm at the random additional discount server 130 must operate in order to satisfy at least one of the following two conditions.

Cₖ−Dₖ≥Dᵢ, C_{T}−D_{T}≥Dᵢ

Although not shown in FIG. 2, there may be a system management server that performs a control function of the entire system by managing the interoperation between the servers and the integration and distribution of related data. However, such function may be distributed and implemented by the afore-mentioned servers, which is not shown in FIG. 2.

Meanwhile, the random additional discount system 100 can provide an equivalent real-time random additional discount service between the buyer terminal 200 and the seller terminal 300 existing in one or more countries through the global network. Where one or more servers of the random additional discount system 100 are used in a plurality of service regions or countries, a function of switching an server to enable the buyer to use the random additional post-payment discount service is performed by one or more of the servers of the random additional discount system 100.

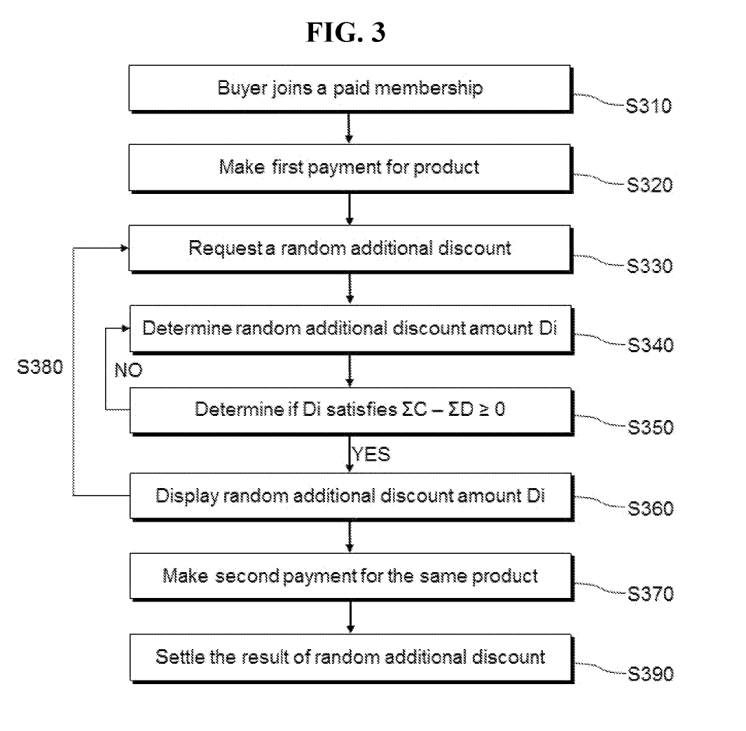

FIG. 3 is a flowchart for a method of performing a random additional post-payment discount according to some embodiments of the present invention.

Hereinafter, exemplary steps of the method for performing a random additional post-payment discount service will be explained with reference to the system configuration of FIG. 2 and the flowchart of FIG. 3.

First, the buyer terminal 200 makes an account and joins for a paid membership at the buyer management server 110 of the random additional discount system 100 providing open market at step S310. At this time, it may be required to agree to pay the monthly membership fee as a condition of paid membership.

Then, the buyer accesses the open market web server 160 using the buyer terminal 200 to search for products, selects a product to be purchased, and performs a first payment at step S320.

Then, the random additional discount server 130 sends a random additional discount request mark to the buyer terminal 200 that made the first payment, and the buyer terminal 200 sends a random additional discount request to the random additional discount server 130 by, for example, clicking the mark at step S330. Alternatively, a random additional discount request may be automatically performed by the buyer's first payment signal being regarded as a request for random additional discount.

The random additional discount server 130 determines a random additional discount amount Dᵢ in response to the random additional discount request from the buyer terminal 200 or the first payment signal at step S340. Subsequently, the random additional discount server 130 determines if the random additional discount amount satisfies the condition of ΣC−ΣD≥0 at step S350.

In FIG. 3, only a condition ΣC−ΣD≥0 (i.e., Cₖ−Dₖ≥0) is displayed assuming that the random additional discount amount Dᵢ is determined for a single seller. However, when the open market operator determines the random additional discount amount Dᵢ for all sellers, the condition should be changed to C_{T}−D_{T}≥0. In the case of determining the future random additional discount amount Dᵢ based on the sales record of the past, it has already been described that each discount amount Dᵢ should be calculated so as to satisfy ΣCₚₐₛₜ≥ΣD_{future} or at least C_{Tpast}≥D_{Tfuture}.

Specifically, when the random additional discount amount Dᵢ for a product i is determined, the random additional discount server 130 determines the suitability of the random additional discount amount Dᵢ using the following condition:

C_{T}−D_{T}≥0

Here, C_{T} is the sum of the sales commissions received from all the sellers by the open market operator for the sales of products during the predetermined period, and D_{T} is the sum of the random additional discount amounts applied to all the products sold by all sellers during the predetermined period.

If the determined random additional discount amount Dᵢ does not satisfy the condition C_{T}−D_{T}≥0, the random additional discount server 130 returns to the step of determining a new random additional discount amount at step S340. If the determined random additional discount amount Dᵢ satisfies the condition C_{T}−D_{T}≥0, then the random additional discount server 130 re-determines the suitability of the random additional discount amount Dᵢ using the following condition:

Cₖ−Dₖ≥0

Here, Cₖ is the sum of all sales commissions received from the specific seller k for the sales of all products of the seller k during the predetermined period, Dₖ is the sum of all random additional discount amounts applied to all the products sold by the specific seller k during the predetermined period.

If the determined random additional discount amount Dᵢ satisfies the condition Cₖ−Dₖ≥0, the random additional discount server 130 displays the determined random additional discount amount Dᵢ on the buyer terminal 200 at step S360.

However, if the determined random additional discount amount Dᵢ does not satisfy the condition Cₖ−Dₖ≥0, the random additional discount server 130 finally determines the suitability of the random additional discount amount Dᵢ using the following condition:

C_{T}−D_{T}≥M_{TH}

That is, even if the sum of the profit of the open market operator due to the sales of products of the seller k during the predetermined period is negative, the random additional discount amount Dᵢ is determined to be provided to the buyer terminal 200 when the sum of the profit of the open market operator due to sales of the products of all sellers including the seller k during the predetermined period is larger than or equal to a predetermined threshold M_{TH} of the open market operator.

If the result of the final determination on the suitability is negative, that is, C_{T}−D_{T}<M_{TH}, then the process returns to the random additional discount amount determination step S340 to determine another random additional discount amount using the random function.

If the determined random additional discount amount Dᵢ does not satisfy the predetermined conditions, the random additional discount server 130 returns to the random additional discount amount determination step at S340 to determine the random additional discount amount again, and this process is repeated until the determined random additional discount amount Dᵢ satisfies the above predetermined conditions.

The random additional discount amount Dᵢ satisfying the predetermined condition and/or the random additional discount price are displayed on the buyer terminal 200 at step S360.

Then, the buyer proceeds with the second payment for the same product at the random additional discount price displayed on the buyer terminal 200 at step S370.

If the buyer is given the option of selecting the final price according to some embodiments, the buyer who is not satisfied with the random additional discount price can send a random additional discount request to the random additional discount server 130 again using the buyer terminal 200 at step S380. To this end, the random additional discount server 130 may transmit a random additional discount price to the buyer terminal 200 and then provide a mark to the buyer terminal 200 inquiring whether the price is satisfactory or whether another random additional discount is desired. In the case of a member who purchased a random additional discount item for a fee, the random additional discount process may be repeated several times.

If the random additional discount process has been repeated two or more times, the buyer terminal 200 may make the second payment by selecting the desired price among the offered several random additional discount prices at step S370.

When the buyer's payment of product is completed, or when a predetermined period for settlement between the open market operator and the seller comes, the open market operator and the seller will settle the result of the random additional discount at step S390.

The settlement procedure that is performed after the buyer's payment for the purchased product is a procedure including the steps of notifying the settlement management server 150 that settlement of the purchased product is completed in the payment management server 140, sending the related data, and updating and storing the payment record for each buyer and seller at the settlement management server 150.

Meanwhile, the settlement procedure performed between the open market operator and the seller at predetermined intervals is a procedure of settling the sum of the sales or payment amount for the predetermined period for each seller and the sum of random additional discount amount provided by the open market operator.

Meanwhile, the settlement management server 150 can compare the amounts of each funds such as a sales commission, a monthly seller member fee, a monthly buyer member fee, a random additional discount amount, and other extra expenses in order to calculate the profit rate and manage the cash flow of the open market operator according to the random additional post-payment discount service. When there is adjustment in the contents of the random additional discount service, the settlement management server may also calculate the changes in profit rate and cash flow of the open market operator by reflecting the changes of the rate of the sales commission, the paid member fee, the random additional discount amount or the random additional discount rate, and so on.

Through the periodical process of calculating profit rate, managing cash flow and accounting records of each buyer and seller, the contents of the random additional discount service may be modified by adjusting the grades of buyer and seller and determining the range of the additional discount rate applied to buyer and/or seller in accordance with the adjusted grades.

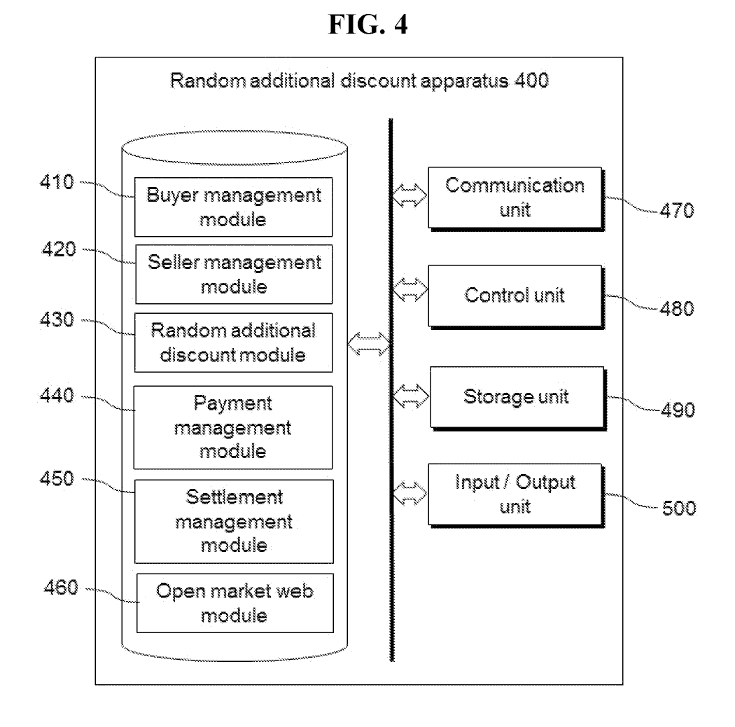

FIG. 4 is a configuration diagram of a post-payment random additional discount apparatus according to some embodiments of the present invention.

Basically, the random additional discount apparatus 400 comprises a communication unit 470 for performing network communication with one or more of a buyer terminal 200, a seller terminal 300, PG 400 and external servers, a control unit 480 for controlling communication between the random additional discount apparatus 400 and the above external terminals and servers and for controlling a plurality of operational modules, storage unit 490 for storing various data and information necessary for a random additional post-payment discount service, and input/output unit 500 for performing input and output of the above various data and information.

One or more software algorithms and related data stored in the storage unit 490 and implemented by the control unit 480 may be classified into several operational modules 410-460 for the random additional post-payment discount service and these features are simultaneously illustrated in FIG. 4.

Thus, from the functional perspective, the random additional discount apparatus 400 comprises a buyer management module 410, a seller management module 420, a random additional discount module 430, a payment management module 440, a settlement management module 450 and an open market web module 460, all of which may be composed by the software algorithm and related data necessary for the random additional post-payment discount service.

In short, the random additional post-payment discount apparatus 400 is a single computer system composed of several modules for buyer management, seller management, random additional discount management, payment management, settlement management and web-site management. Of course, some or all the above modules may be implemented as a hardware, middleware or software and the functions of these modules are the same as or similar to those servers in the random additional discount system in FIG. 2, so a detailed description thereof will be omitted.

The above-described embodiments of the present invention can be implemented in the form of program instructions that can be executed through various computer components and recorded on a computer-readable recording medium. The computer-readable recording medium may include program commands, data files, data structures, and the like, alone or in combination thereof. The program instructions recorded on the computer-readable recording medium may be those specially designed and constructed for the implementation of the present invention or may be those known to those skilled in the computer software arts.

Examples of computer-readable recording media include magnetic media such as hard disks, floppy disks and magnetic tape, optical recording media such as CD-ROMs and DVDs, magneto-optical media such as floptical disk, and memory devices that are specially configured to store and execute program instructions such as ROM, RAM and flash memory.

Examples of program instructions include machine language code such as those produced by a compiler, as well as high-level language code that can be executed by a computer using an interpreter or the like. The hardware devices described herein may be configured to operate in the form of one or more software modules for performing the processes according to the present invention, and vice versa.

While the present invention has been described in connection with what is presently considered to be the most practical and preferred embodiments, it is to be understood that the invention is not limited to the disclosed embodiments, but, on the contrary, it will be understood by those skilled in the art that various changes in form and details may be made therein without departing from the spirit and scope of the invention as defined by the appended claims. It is therefore to be understood that the above-described embodiments are illustrative and non-restrictive in every respect. For example, each component described as a single entity may be distributed and implemented, and components described as being distributed may also be implemented in a combined form. Accordingly, the true scope of the present invention should be determined only by the appended claims.

1. A random additional discount apparatus for receiving at least one random additional discount target product from a seller terminal, receiving a random additional discount request from a buyer terminal upon payment for a purchase of the product and providing a random additional discount price to the buyer terminal in response to the random additional discount request,
wherein the apparatus is configured to:
extract a random additional discount amount in response to the random additional discount request;
determine whether the extracted random additional discount amount satisfies a predetermined condition;
transmit the random additional discount price determined by the random additional discount amount satisfying the predetermined condition to the buyer terminal; and
repeat the process of extracting a new random additional discount amount and determining whether the new random additional discount amount satisfies the predetermined condition, and
wherein the predetermined condition that the determined random additional discount amount Dᵢ should satisfy is
ΣCₖ−ΣDₖ≥0,
when M sellers sell products on the open market the total result of product sales by the M seller for a predetermined period of time is summarized as follows:
R_{T}=ΣR₁+ΣR₂+ . . . ΣRₖ+ . . . +ΣR_{M}
(Here, ΣRₖ=sales revenue of the seller k, R_{T}=total sales revenue of all the M sellers);
C_{T}=ΣC₁+ΣC₂+ . . . ΣCₖ+ . . . +ΣC_{M}
(Here, ΣCₖ=sales commission received from the seller k, C_{T}=total sales commission received from all the M sellers);
D_{T}=ΣD₁+ΣD₂+ . . . ΣDₖ+ . . . +ΣD_{M}
(Here, ΣDₖ=discount subsidy provided by the open market operator for the sales of the product of the seller k, D_{T}=total discount subsidy provided by the open market operator for the sales of the products of all the M sellers).

2. A random additional discount apparatus for receiving at least one random additional discount target product from a seller terminal, receiving a random additional discount request from a buyer terminal upon payment for a purchase of the random additional discount target product and providing a random additional discount price to the buyer terminal in response to the random additional discount request,
wherein the apparatus is configured to:
extract a random additional discount amount in response to the random additional discount request;
determine whether the extracted random additional discount amount satisfies a predetermined condition;
transmit the random additional discount price determined by the random additional discount amount satisfying the predetermined condition to the buyer terminal; and
repeat the process of extracting a new random additional discount amount and determining whether the new random additional discount amount satisfies the predetermined condition, and
wherein the predetermined condition that the determined random additional discount amount Dᵢ should satisfy is
C_{T}−D_{T}≥0,
when M sellers sell products on the open market the total result of product sales by the M seller for a predetermined period of time is summarized as follows:
R_{T}=ΣR₁+ΣR₂+ . . . ΣRₖ+ . . . +ΣR_{M}
(Here, ΣRₖ=sales revenue of the seller k, R_{T}=total sales revenue of all the M sellers);
C_{T}=ΣC₁+ΣC₂+ . . . ΣCₖ+ . . . +ΣC_{M}
(Here, ΣCₖ=sales commission received from the seller k, C_{T}=total sales commission received from all the M sellers);
D_{T}=ΣD₁+ΣD₂+ . . . ΣDₖ+ . . . +ΣD_{M}
(Here, ΣDₖ=discount subsidy provided by the open market operator for the sales of the product of the seller k, D_{T}=total discount subsidy provided by the open market operator for the sales of the products of all the M sellers).

3. The random additional discount apparatus of claim 2,
wherein the predetermined condition that the determined random additional discount amount D, should satisfy is
C_{T}−D_{T}≥0 and ΣCₖ−ΣDₖ≥0,
wherein,
if Cₖ−Dₖ<0 then it is determined whether the condition C_{T}−D_{T}≥M_{TH} is satisfied;
if the condition C_{T}−D_{T}≥M_{TH} is satisfied then the determined random additional discount price is transmitted to the buyer terminal;
if the condition C_{T}−D_{T}≥M_{TH} is not satisfied then the process of extracting a new random additional discount amount and determining whether the new random additional discount amount satisfies the above conditions is repeated; and
M_{TH} is the threshold margin of the open market operator for the sales of products of all the M sellers for the predetermined period.

4. The random additional discount apparatus of claim 3,
wherein the total amount of the discount subsidy that will be applied to the random additional discount service is displayed on the buyer terminal.

5. A random additional discount method provided by a random additional discount apparatus for receiving at least one random additional discount target product from a seller terminal, receiving a random additional discount request from a buyer terminal upon payment for a purchase of the random additional discount target product and providing a random additional discount price to the buyer terminal in response to the random additional discount request,
wherein the method comprises:
receiving from the seller terminal the seller information and at least one random additional discount target product for registration;
receiving from the buyer terminal the buyer information and payment completion information for a product to purchase;
in response to the payment completion information, transmitting at least one random additional discount price to the buyer terminal; and
receiving from the buyer terminal a purchase decision,
wherein the transmitting further comprises:
extracting a random additional discount amount;
determining whether the extracted random additional discount amount satisfies a predetermined condition;
when the determined random additional discount amount satisfies the predetermined condition, transmitting the determined random additional discount price to the buyer terminal; and
when the determined random additional discount amount does not satisfy the predetermined condition, repeating the steps of extracting a new random additional discount amount, determining whether the new random additional discount amount satisfies the predetermined condition and transmitting the determined new random additional discount price satisfying the predetermined condition to the buyer terminal, and
wherein the predetermined condition that the determined random additional discount amount Dᵢ should satisfy is
C_{T}−D_{T}≥0,
wherein, when M sellers sell products on the open market the total result of product sales by the M seller for a predetermined period of time is summarized as follows:
R_{T}=ΣR₁+ΣR₂+ . . . ΣRₖ+ . . . +ΣR_{M}
(Here, ΣRₖ=sales revenue of the seller k, R_{T}=total sales revenue of all the M sellers);
C_{T}=ΣC₁+ΣC₂+ . . . ΣCₖ+ . . . +ΣC_{M}
(Here, ΣCₖ=sales commission received from the seller k, C_{T}=total sales commission received from all the M sellers);
D_{T}=ΣD₁+ΣD₂+ . . . ΣDₖ+ . . . +ΣD_{M}
(Here, ΣDₖ=discount subsidy provided by the open market operator for the sales of the product of the seller k, D_{T}=total discount subsidy provided by the open market operator for the sales of the products of all the M sellers).

6. The random additional discount method of claim 5,
wherein the predetermined condition that the determined random additional discount amount Dᵢ should satisfy is
C_{T}−D_{T}≥0 and ΣCₖ−ΣDₖ≥0,
wherein,
if Cₖ−Dₖ<0 then it is determined whether the condition C_{T}−D_{T}≥M_{TH} is satisfied;
if the condition C_{T}−D_{T}≥M_{TH} is satisfied then the determined random additional discount price is transmitted to the buyer terminal;
if the condition C_{T}−D_{T}≥M_{TH} is not satisfied then the process of extracting a new random additional discount amount and determining whether the new random additional discount amount satisfies the above conditions is repeated; and
M_{TH} is the threshold margin of the open market operator for the sales of products of all the M sellers for the predetermined period.

7. The random additional discount method of claim 6,
wherein the total amount of the discount subsidy that will be applied to the random additional discount service is displayed on the buyer terminal.

8. The random additional discount method of claim 6, further comprises:
after receiving the payment completion information, transmitting a random additional discount request mark to the buyer terminal, and
the random additional discount request from the buyer terminal is implemented by the selection of the random additional discount request mark by the buyer terminal.

9. The random additional discount method of claim 6,
wherein the random additional discount price is between 1% and 100% of the initial price of the product contained in the payment completion information.

10. The random additional discount method of claim 6,
wherein the transmitting of the random additional discount price further comprises:
in response to the random additional discount request, transmitting a first random additional discount price to the buyer terminal;
receiving again the random additional discount request from the buyer terminal; and
transmitting a second random additional discount price to the buyer terminal, and
the receiving of the purchase decision from the buyer terminal further comprises:
receiving the purchase decision corresponding to one of the first and second random additional prices.
